(19) United States
(12) Patent Application Publication
(10) Pub. No.: US 2007/0086908 A1
(43) Pub. Date: Apr. 19, 2007

(54) Volumetric screw compressor

(76) Inventors: Enrico Faccio, Cologna Veneta (IT); Andrea Tonin, Brogliano (IT)

Correspondence Address: IP STRATEGIES, 12 1/2 WALL STREET, SUITE I, ASHEVILLE, NC, 28801, US

(21) Appl. No.: 11/529,654

(22) Filed: Sep. 28, 2006

(30) Foreign Application Priority Data
Oct. 14, 2005 (IT) VI2005A000272

(51) Int. Cl. F04C 2/00; F04C 18/00; F03C 4/00; F03C 2/00

(52) U.S. Cl. 418/201.1

(57) ABSTRACT

Volumetric compressor comprising a casing forming an intake chamber and a delivery chamber, a pair of screw rotors coming between the intake chamber and delivery chamber, a container for containing a high-pressure fluid, associated with the casing, a capacity regulating device associated with the casing, which includes a slide valve cooperating with the rotors, a fluid-operated actuator comprising a cylinder complete with a bottom and a head with a through hole for the passage of a stem having one end associated with a piston sliding inside the cylinder and the opposite end associated with the slide valve, channels obtained in the cylinder, a pipe for delivering the fluid, which connects the container to one of the channels and outlets for the fluid which connect the channels to the intake chamber, shut-off solenoid valves installed inside the outlets and a control unit connected to the shut-off solenoid valves. The top end of the slide valve faces the delivery chamber so that the stem is submitted to a compressive force.

### BACKGROUND OF THE INVENTION

This invention relates to a volumetric screw compressor of improved design, and particularly of the type complete with a capacity regulating device. To be more precise, the invention relates to a screw compressor comprising a casing containing an intake chamber complete with an intake valve and a delivery chamber complete with a delivery valve.

A pair of screw rotors engaging with each other are installed between the intake chamber and the delivery chamber, and there is a sump containing lubricant oil in the bottom of the casing.

It is common knowledge that volumetric screw compressors of the type briefly described above come complete with capacity regulating devices that comprise a slide valve cooperating externally with the rotors and displaced by a fluid-operated actuator in a longitudinal direction, parallel to the longitudinal axis of said two rotors.

The fluid-operated actuator comprises a cylinder containing an active chamber, fed by suitable pumping means with a fluid, e.g. oil, drawn from the high-pressure side, e.g. from the sump, in variable quantities depending on the operating parameters.

This enables the sliding movement of a piston that is contained inside the cylinder and complete with a stem that connects it to the slide valve.

The shell and bottom of the fluid-operated actuator contain a plurality of channels that are connected to a corresponding number of outlets that transfer the fluid from the actuator's active chamber to the compressor's intake chamber.

To be more precise, these channels are arranged one on the bottom and generally two on the shell, aligned parallel to the sliding direction of the piston and at different axial distances from the bottom.

The outlets are fitted internally with flow shut-off valves, the selective opening and closing of which enables different quantities of fluid to be delivered to the actuator's active chamber.

The piston and consequently also the slide valve connected thereto by means of the stem can thus occupy different axial positions with respect to the rotors and thereby give rise to a reduction of the compressor's intake and a consequent modification of its capacity.

The entity of the reduction of the compressor's capacity therefore depends both on the position of the channels on the actuator and on which of the shut-off valves are opened and which of them remain closed.

An example of a volumetric screw compressor of the above-mentioned type is described in the European patent EP 1 072 796, which explains how an electric/electronic control device connected to the shut-off valve actuators on the outlets is used to control the opening and closing of said valves to reduce the capacity of the compressor, depending on the user's needs.

Another embodiment, forming the object of the international patent application PCT/EP 2005/050933, filed by the same applicant as the present invention, involves a different device equipped with a suitable flow diverter switch for adjusting the compressor's capacity by reducing the flow rate of the fluid.

Be that as it may, the volumetric screw compressors of known type, with the structural characteristics summarized above, present several acknowledged drawbacks.

The first drawback lies in that the stem connecting the piston to the slide valve is loaded with a tensile force whatever the capacity configuration used to operate the compressor, and also during the brief transients when the compressor is switched from one operating condition to another to reduce its capacity.

This is due to the effect of the pressure gradient that is created between the surfaces of the piston (which is in contact with the high-pressure delivery chamber on one side and with the active chamber—at the pressure of the fluid—on the other) and the surfaces of the slide valve (which is in contact with the low-pressure intake chamber on one side and with the high-pressure delivery chamber on the other).

Tensile forces exerted for a given period of time on mechanical components such as the stem carry risks of damage and even failure, located particularly at the end of the stem connected to the slide valve, with the further disadvantage of irreparably damaging the functional capacity of the compressor.

Another drawback derives from the fact that any damage or failure of the above-mentioned stem entails the need for repairs or replacements, which always pose problems for the user because of the costs and the waiting and plant stoppage times associated therewith.

The present invention intends to overcome the above-mentioned drawbacks.

### SUMMARY OF THE INVENTION

In particular, the main object of the invention is to produce a volumetric screw compressor complete with a capacity regulating device wherein the stem in the fluid-operated actuator that connects the piston to the slide valve is submitted, when in operation, to almost exclusively compressive forces rather than to tensile stresses, as is the case with the compressors of known type.

The object of the invention is thus to reduce the risk, by comparison with the known state of the art, of irreparable damage to, or failure of the stem belonging to the capacity regulating device in a volumetric screw compressor, thereby making the system for reducing the flow rate more reliable.

Another, not necessarily last object of the invention is to restrict, by comparison with the known state of the art, the need for repairs and replacements of the stem connecting the piston to the slide valve in the capacity regulating devices installed in volumetric screw compressors.

The aforesaid objects have been achieved through the construction of an improved volumetric screw compressor that, in accordance with the first claim, comprises:
a casing containing an intake chamber and a delivery chamber;
a pair of screw rotors coming between said intake chamber and said delivery chamber;
a high-pressure fluid container associated with said casing;
a capacity regulating device associated with said casing, which includes:
   a slide valve cooperating externally with said rotors;
   a fluid-operated actuator comprising a cylinder, with a bottom and a head provided with a through hole for the passage of a stem having one end associated with a piston slidingly inserted in said cylinder and the opposite end associated with said slide valve;
   a plurality of channels obtained in said cylinder;
   at least one fluid delivery pipe connecting said container to one of said channels;
   a plurality of fluid outlets connecting said channels to said intake chamber;
   a plurality of shut-off solenoid valves installed inside said fluid outlets;
   at least one control unit, electrically connected to said shut-off solenoid valves,
      and wherein the top of said slide valve faces said delivery chamber so that said stem connecting said slide valve to said piston is submitted to a compressive force.

The invention advantageously enables an improvement, by comparison with the volumetric compressors of known type, in the reliability of the control device for regulating the reduction of the compressor's capacity.

In fact, by comparison with the known state of the art, the volumetric compressor described herein restricts the risk-of damage or failure of the fluid-operated actuator stem, which is known to be capable of interfering with the compressor's operation.

This is due to the fact that, both when the compressor is operating at a given capacity and during the displacement of the piston to vary said capacity, the stem connecting the piston to the slide valve is submitted to a compressive force, instead of the tensile force involved in the case of similar compressors of known type.

Another advantage of the invention lies in that, by comparison with the known state of the art, it reduces the need for repairs and replacements as a consequence of damage to, or the failure of components of the capacity regulating device.

A further advantage lies in that the new, internal arrangement of the mechanical components of the capacity regulating device of the invention enables structural benefits to be obtained that give rise to a more compact and lighter volumetric compressor than similar compressors of known type.

This is because, according to the invention, the cylinder that contains the stem is obtained in the compressor casing, whereas in equivalent compressors of known type the cylinder forms part of a body that is assembled inside the casing, opposite the slide valve, with the aid of fixing means of known type, such as studs.

As a consequence, another advantage of the invention lies in that the volumetric compressor described herein is easier to assemble and service than those made according to the previous state of the art.

### BRIEF DESCRIPTION OF THE DRAWINGS

Further characteristics and particular features of the volumetric compressor forming the object of the present patent application will be better illustrated in the description of preferred embodiments of the invention, provided here for illustrative purposes in relation to the attached drawings, wherein:

FIG. 1 shows a simplified axonometric view with a cut-away section of the volumetric compressor of the invention;

FIG. 2 shows a first enlarged detail from FIG. 1;

FIGS. 3 to 6 show cross-sections of the compressor of FIG. 1 in different operating conditions;

FIG. 3a shows an enlargement of a detail from FIG. 3;

FIG. 7 shows a second enlargement of a detail from FIG. 1;

FIG. 8 shows a variant of the compressor of FIG. 3;

FIG. 9 shows an enlargement of a detail from FIG. 8.

### DESCRIPTION OF THE INVENTION

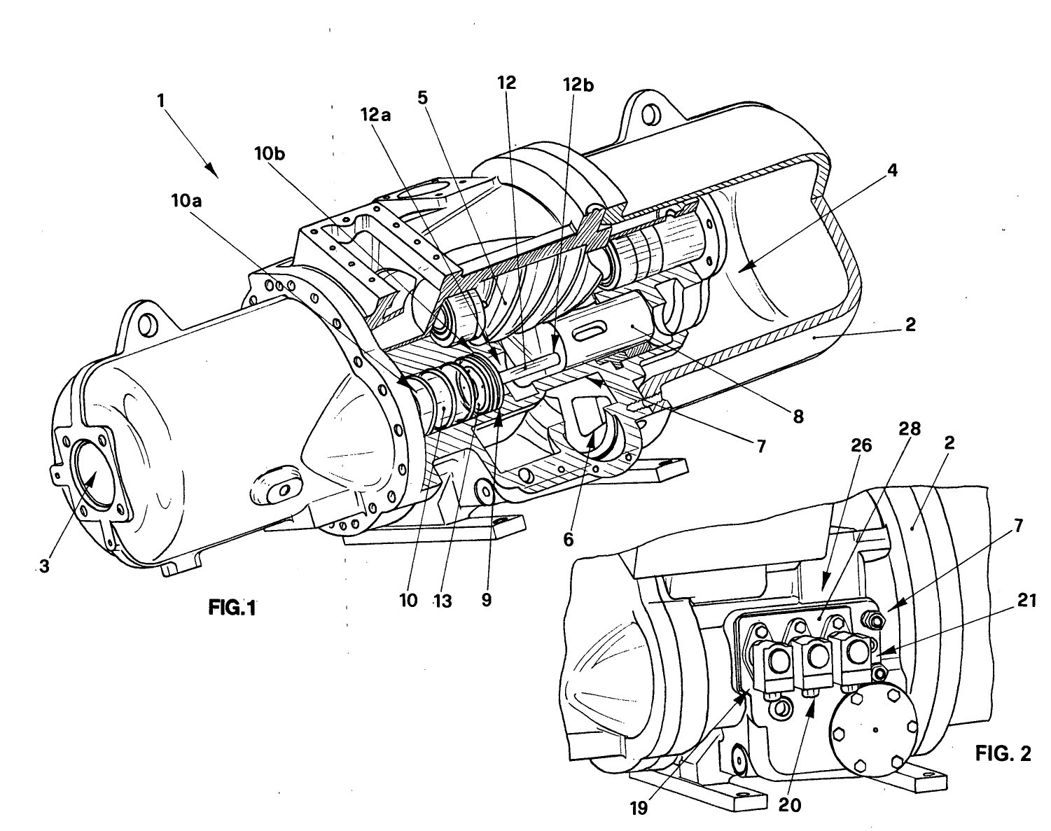

The volumetric screw compressor of the invention is illustrated in FIG. 1, where it is indicated as a whole by the numeral 1.

The volumetric compressor 1 is of the type already known to a person skilled in the art and comprises a casing 2 containing an intake chamber 3, a delivery chamber 4 and a pair of screw rotors, only one of which is visible in the figure and indicated by the numeral 5, coming between the intake chamber 3 and the delivery chamber 4.

The volumetric compressor 1 also comprises a container 6, consisting in this case of a sump created in the bottom 2a of the casing 2, which contains a high-pressure fluid O, e.g. oil.

In other embodiments, not illustrated in the attached drawings, the container for the fluid driving the piston may consist of a tank installed outside the casing and communicating therewith by means of piping.

Moreover, the use of a fluid other than oil, e.g. gas, can be considered to drive the piston.

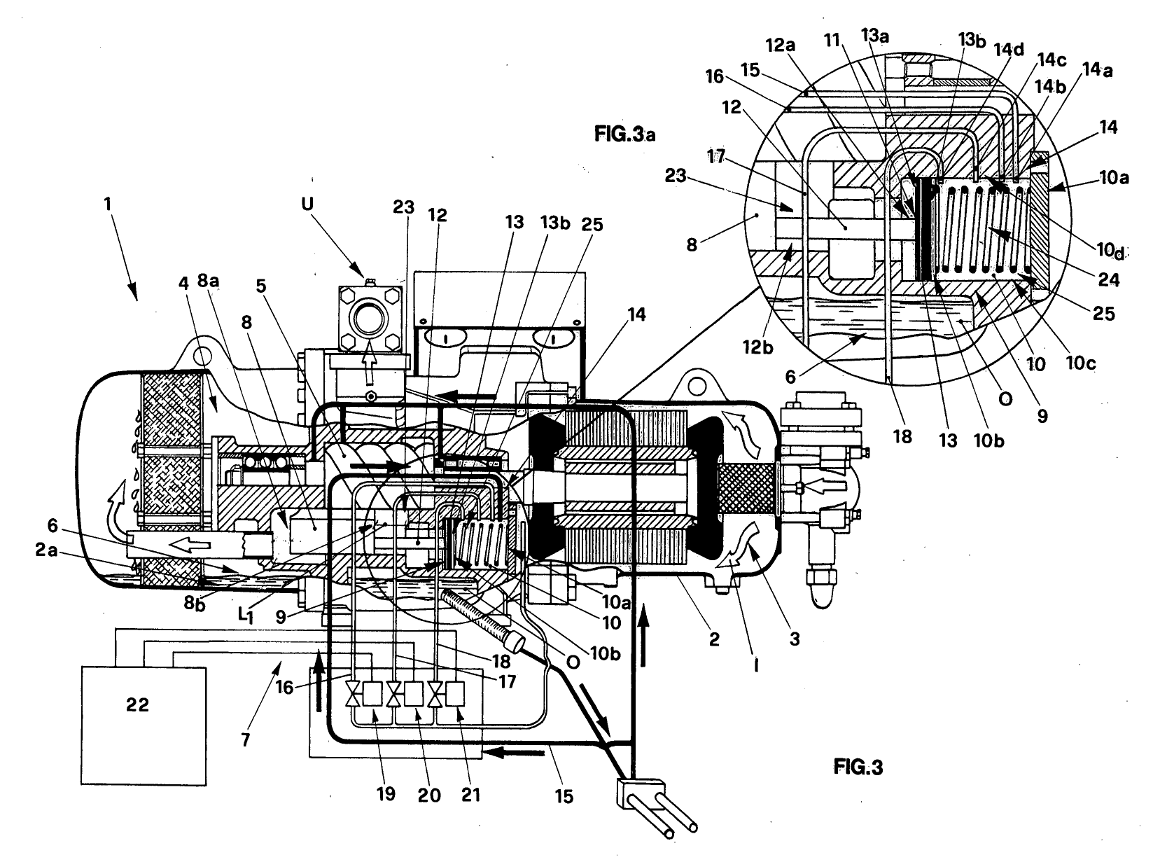

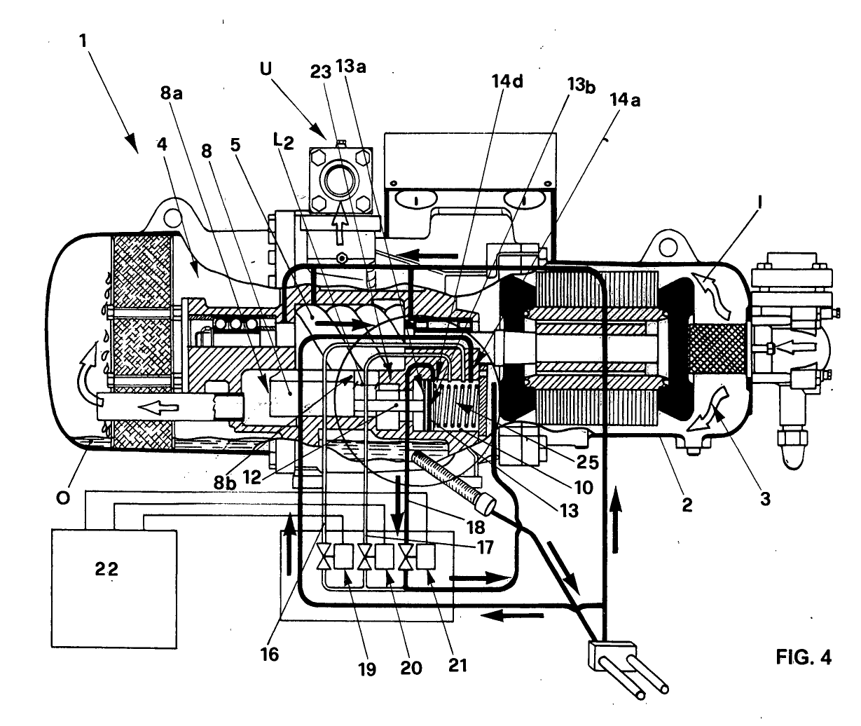

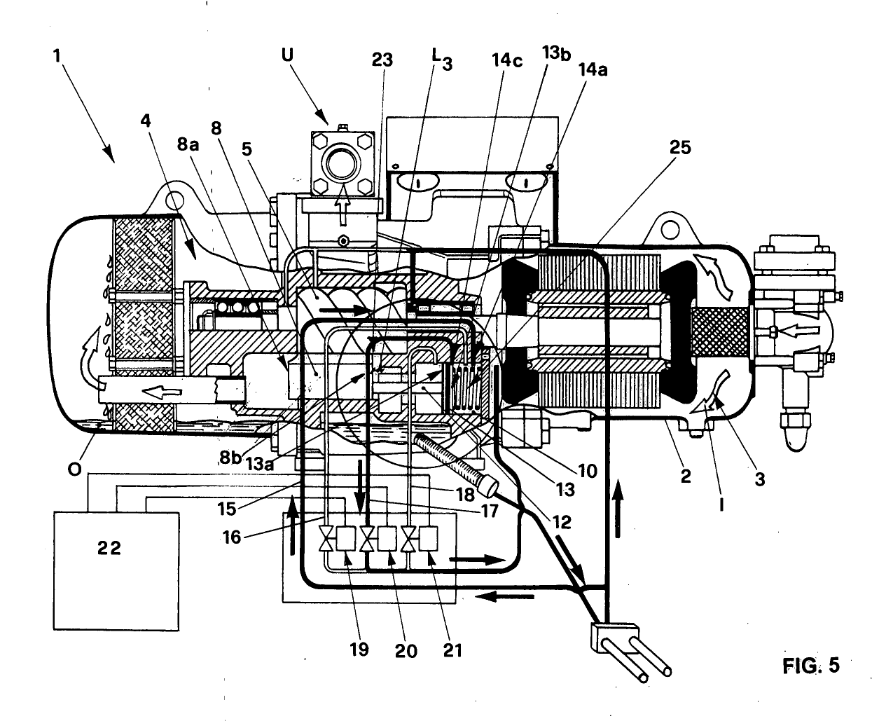

The compressor 1 also comprises a capacity regulating device, visible in FIGS. 1 and 2, but illustrated in greater detail in FIG. 3, where it is indicated as a whole by the numeral 7, which includes:
a slide valve 8 cooperating externally with the rotors 5;
a fluid-operated actuator, generally indicated by the numeral 9, comprising a cylinder 10, with a bottom 10a at one end and a head 10b at the other with a through hole 11 for the passage of a stem 12 having one end 12a associated with a piston 13 sliding inside the cylinder 10, and the opposite end 12b associated with the slide valve 8;
a plurality of channels 14 obtained in the cylinder 10;
a pipe 15 for the delivery of the fluid O, which connects the container 6 to one of the channels 14;
a plurality of outlets 16, 17, 18 for the fluid O, connecting the channels 14 to the intake chamber 3;
a plurality of shut-off solenoid valves 19, 20, 21, installed in respective outlets 16, 17, 18;
a control unit, indicated as a whole by the numeral 22, electrically connected to the shut-off solenoid valves 19, 20, 21.

According to the invention, the top end 8a of the slide valve 8 faces the delivery chamber 4 so that the stem 12 connecting the slide valve 8 to the piston 13 is submitted to a compressive stress.

FIG. 1, in particular, shows that the cylinder 10 of the fluid-operated actuator 9 is obtained directly on the casing 2, with which it forms a single body. This structural feature means that the volumetric compressor 1 has a lower weight and smaller overall dimensions than equivalent compressors based on the known state of the art, as well as a more straightforward assembly.

In fact, the invention avoids the need to complete the steps required in the assembly of known compressors, consisting in coupling the body containing the fluid-operated actuator cylinder to the inside wall of the casing, using fixing means whose point of application has to be accurately calculated to achieve the proper connection of the slide valve to the cylinder.

The bottom 10a of the cylinder 10 is positioned facing the intake chamber 3, while the stem 12 is positioned in line with a central area 23 of the casing 2 connected to the intake chamber 3 and therefore always at a low pressure. Given these structural features, the slide valve 8 comes between the rotors 5 and the container 6 for the fluid O.

Preferably, but not necessarily, the volumetric compressor 1 comprises elastic means, generally indicated by the numeral 24, coming between the piston 13 and the bottom 10a of the cylinder 10, and cooperating with the piston 13 so as to return the slide valve 8 to its starting position when the compressor 1 is switched off, said starting position coinciding with the minimum capacity configuration illustrated in FIG. 3.

This complies with the manufacturers' recommendations in the user manuals, i.e. that the compressor should always be started on a minimum capacity setting, which coincides in the invention with the situation wherein the stem 12 extends as far as possible outside the cylinder 10.

The elastic means 24 are provided in line with an active chamber 25 inside the cylinder 10, between the piston 13 and the bottom 10a, into which the fluid O is delivered.

As shown in FIG. 3, the channels 14 are aligned with one another and, in this case, are obtained in the shell 10c of the cylinder 10 in line with the active chamber 25.

Moreover, the channels 14 are arranged at different distances from the bottom 10a of the cylinder 10, according to a structural design known in the field.

To be more precise, as shown in FIG. 3a, there are four channels 14, including a first channel 14a and a second channel 14b created in the shell 10c of the cylinder 10, near the bottom 10b of said cylinder, and third and fourth channels, respectively 14c and 14d, created basically in the central portion 10d of the shell 10c of the cylinder 10.

The pipe 15 for delivering the fluid O connects the container 6 to the first channel 14a, while the outlets 16, 17, 18 belonging to the capacity regulating device 7 respectively connect the second channel 14b, the third channel 14c and the fourth channel 14d of the cylinder 10 of the fluid-operated actuator 9 to the intake chamber 3.

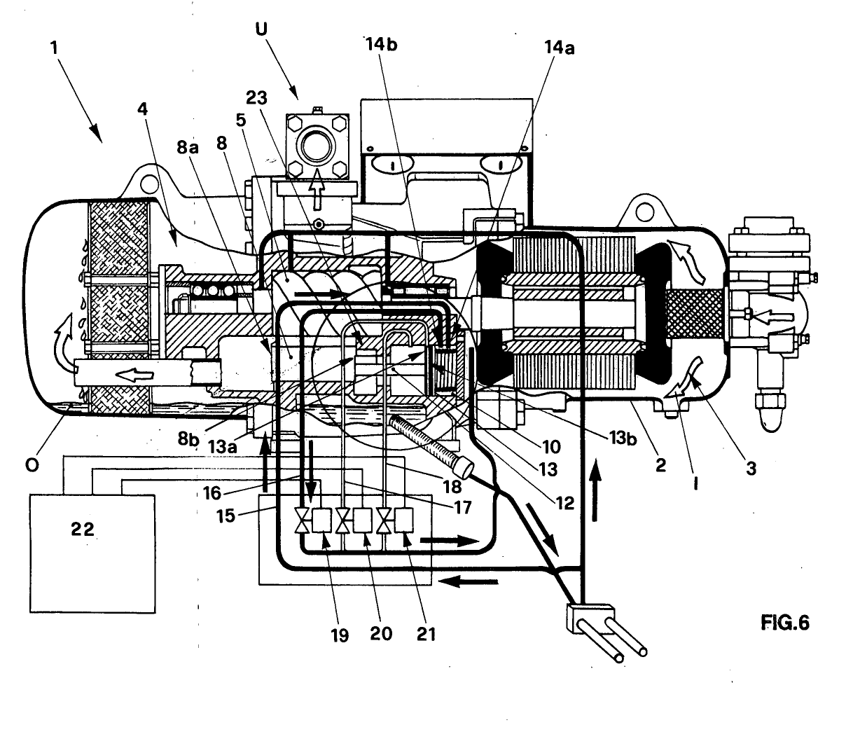

The control unit 22, e.g. a PLC, comprises means (not illustrated herein for the sake of simplicity) for opening/closing the shut-off solenoid valves 19, 20, 21. According to the preferred embodiment of the invention described herein, the capacity regulating device 7 comprises a flow diverter switch, indicated as a whole by the numeral 26, shown in FIG. 2, and again in FIG. 7, which connects the active chamber 25 to the container 6 and to the intake chamber 3.

The switch 26 preferably consists of a simple static flow diverter 27 removably associated with the shut-off solenoid valves 19, 20, 21 and used to obtain discretely variable compressed fluid flow rates as a function of the energized or de-energized state of the shut-off solenoid valves 19, 20, 21.

The static flow diverter 27 is a gasket containing the paths of the fluid O, installed between the casing 2 and the plate 28, clearly visible in FIG. 2, and supporting the shut-off solenoid valves 19, 20, 21.

This first embodiment of the invention enables the flow rates of the compressed fluid O to the delivery chamber 4 of the compressor 1 to be varied discretely according to the opening and closing position of the shut-off solenoid valves 19, 20, 21, as illustrated in FIGS. 3 to 6, which show the compressor 1 in different operating conditions.

From a functional point of view, a first operating condition of the volumetric compressor 1, that is particularly recommended—as mentioned previously—when starting the compressor, is illustrated in FIG. 3, where boldface characters are used to indicate the piping in which the fluid O flows.

In this case, the shut-off solenoid valves 19, 20, 21 are closed and the fluid O flows from the container 6 to the active chamber 25 through the delivery pipe 15 and the first channel 14a, bringing the piston 13 into line with the head 10b of the cylinder 10.

This coincides with the complete opening of the slide valve 8 and, since it is located in the delivery chamber 4, the flow of gas I in the compressor I passing through the opening L₁ is the minimum allowable, corresponding to 25% of the total.

In fact, with the slide valve 8 fully open, most of the flow of gas I that is delivered is recirculated from the central area 23 to the intake chamber 3.

FIG. 4 shows a second operating condition of the compressor 1 of the invention, wherein the shut-off solenoid valve 21 is opened so that the fourth channel 14d discharges part of the fluid O contained in the active chamber 25 into the intake chamber 3, through the outlet 18, displacing the piston 13 and consequently also the slide valve 8 in the direction indicated by the arrow V, which is opposite to the direction of the gas flow I.

The displacement of the slide valve 8 is caused by the pressure difference between the high-pressure top end 8a and the opposite low-pressure surface 8b on one side, and the low-pressure front surface 13a and the rear surface 13b at the pressure of the fluid O in the active chamber 25 on the other—a difference that generates a compressive force on the stem 12.

Said displacement produces an opening L₂ smaller than L₁ in the central area 23 of the compressor 1, thus increasing the flow rate of the compressed gas I available at the user point U.

By comparison with the situation shown in FIG. 3, the extent of the increase in the compressed gas flow rate I, which depends on the quantity of fluid O discharged from the, active chamber 25 and thus on the position of the fourth channel 14d, is 25%, so in this case the capacity amounts to 50% of the total. FIG. 5 shows the third mode of operating the compressor 1, again with the flow of the fluid O shown in boldface type.

This time, only the shut-off solenoid valve 20 is opened, so that the third channel 14c discharges the fluid O from the active chamber 25 into the intake chamber 3 of the compressor 1 through the outlet 17.

This induces a consequent displacement of the piston 13 in the same direction as in the previous case, as shown by the arrow V, but over a longer stretch than the one shown in FIG. 4, which enables the formation of an opening L₃ smaller than L₂ in the central area 23 and generates a more marked increase in the flow rate of compressed gas I to the user point U.

In fact, the position of the third channel 14c, coming between the first channel 14a and the fourth channel 14d, coincides with a greater discharge of fluid O from the active chamber 25 than in the condition shown in FIG. 4 and, in this specific case, achieves a capacity corresponding to 75% of the total.

Finally, FIG. 6 shows the fourth operating condition for the compressor 1, with the shut-off solenoid valve 19 opened and the piston 13 fully withdrawn inside the cylinder 10.

The second channel 14b discharges the fluid O from the active chamber 25 into the intake chamber 3 of the compressor 1 through the outlet 16, with the corresponding displacement of the piston 13 in the direction of the arrow V, which—as in the previous cases—goes against the flow of the gas I.

In this operating condition, the opening in the central area 23 is completely closed and the whole gas intake I is compressed, achieving 100% of the total capacity of the compressor.

When the compressor 1 is switched off, whatever the configuration in which it was previously being operated, the elastic means 24 automatically restore the piston 13 to the initial conditions in which the flow rate amounted to 25% of the total.

In all the above-mentioned operating conditions of the compressor 1, the stem 12 is submitted to a compressive force, due to the fact that the slide valve 8 is positioned with its top end 8a facing towards the delivery chamber 4.

The stem 12, positioned virtually in the low-pressure central area 23 of the casing 2, is under a compressive force both under normal operating conditions and during the displacement of the piston 13 due to the effect of the force resulting from the pressure difference between the surfaces 8a and 8b of the slide valve 8 and the surfaces 13a and 13b of the piston 13.

This differs from the arrangement in similar compressors of known type, wherein the stem comes under a tensile force and is consequently liable to damage or failure.

The invention thus achieves the object of producing a more reliable volumetric screw compressor, consequently reducing the need—by comparison with the known state of the art—for repairs and/or replacements, which are always unwanted.

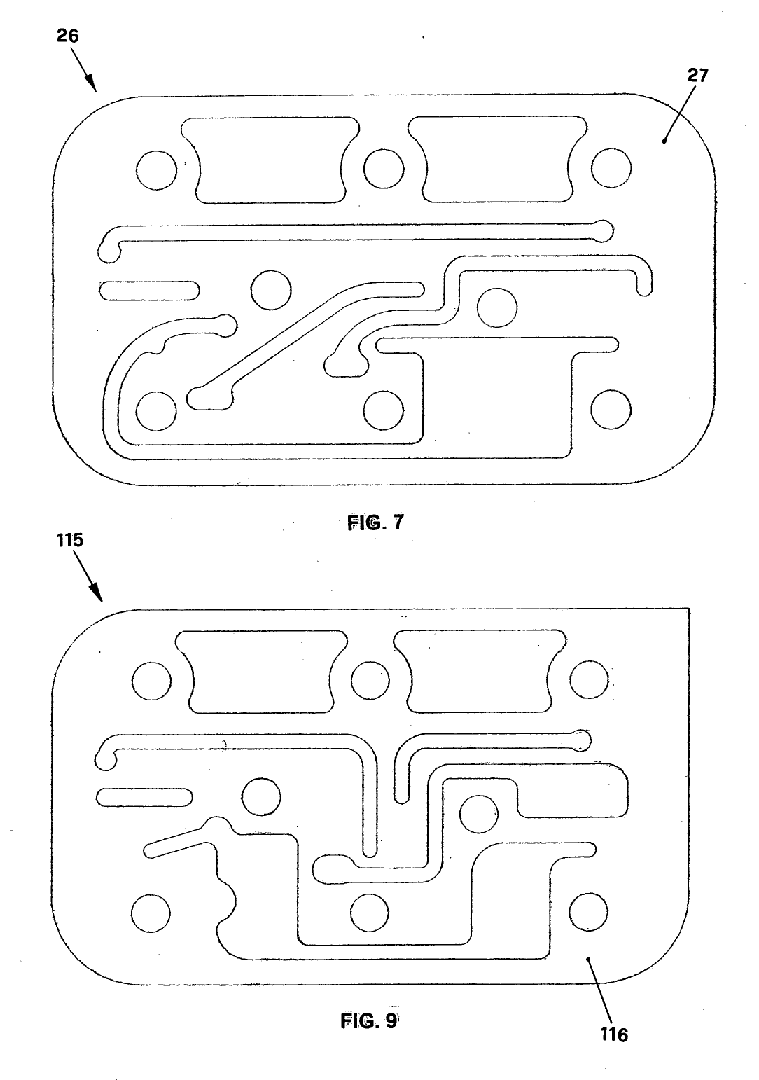

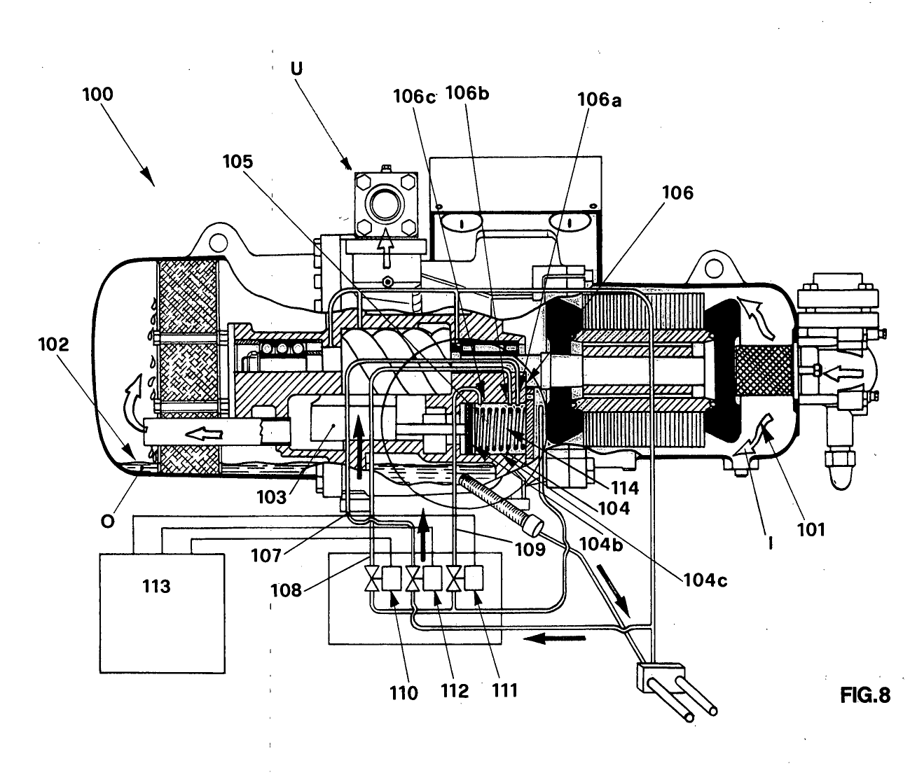

FIG. 8 shows a variant of the invention, wherein the compressor, indicated as a whole by the numeral 100, differs from the one previously described in that it comprises a flow diverter switch, indicated as a whole by the numeral 115, consisting of a different static flow diverter 116, illustrated in FIG. 9.

In fact, the static flow diverter 116 consists of a gasket different from that of the previous static flow diverter shown in FIG. 7, the purpose of which is to enable the compressed fluid flow rates to be varied continually instead of discretely, as in the compressor 1.

This is achieved because the active chamber 114 of the cylinder 104 is not fed continually with the fluid O through a dedicated delivery pipe, as in the compressor 1.

In this embodiment of the invention, the delivery pipe, indicated by the numeral 107, coincides with the outlet 17 of the compressor 1, thus achieving a capacity that is 75% of the total capacity.

The delivery pipe 107 thus connects the container 102 to the active chamber 114 via the first channel 106a and contains the shut-off solenoid valve 112. Another difference in the structural design of the compressor 100 lies in the number of channels 106 on the shell 104c of the cylinder 104: in this case there are three channels, indicated by the numerals 106a, 106b and 106c.

The control unit 113 opens or closes the shut-off solenoid valve 112, depending on the operating needs, thereby continuously adjusting the flow rate of the compressed gas.

In operating terms, when the compressor 100 is started up, only the shut-off solenoid valve 112 is opened to carry the fluid O into the active chamber 114 and obtain a flow of compressed gas I corresponding to 25% of the compressor's total capacity.

Afterwards, the shut-off solenoid valve 112 can be kept open and the compressor 1 can be operated in the manner previously explained, opening one of the two shut-off valves 110, 111, installed in the respective outlets 108, 109, associated one with the second channel 106b and the other with the third channel 106c, and discharging the corresponding quality of fluid O into the intake chamber 101.

In so doing, the resulting flow rate of the compressed gas I corresponds respectively to 100% or 50% of the total capacity of the compressor.

It should be noted that the decision to operate the compressor with a continuous flow to the active chamber 114 through the delivery pipe 107 makes it impossible to obtain a flow rate corresponding to 75% of the total capacity.

The compressor 100 does enable intermediate capacities to be obtained, however, that come between those mentioned above, if the shut-off solenoid valve 112 is closed after the fluid O has been delivered to the active chamber 114.

In these operating conditions, opening one of the shut-off solenoid valves 110, 111 for pre-set time intervals that are shorter than those needed to obtain compressed gas flow rates I corresponding to 100% or 50% of the maximum capacity makes the piston 105 stop in an intermediate position between the various channels 106 in the cylinder 104.

This consequently enables the pressure in the active chamber 114 to be gradually released and provides flow rates of the compressed gas I at the user point U of the compressor 100 that vary from 100% to 50% of the total value.

The value of each intermediate flow rate depends on the opening time of the shut-off solenoid valve 112 after the active chamber 114 of the cylinder 104 has been filled with the fluid O.

Conversely, opening the shut-off solenoid valve 112 for variable time intervals, starting from the operating condition that achieves 100% of the flow rate, enables a reduction in the flow rate to any value between 100% and 25% of the total value.

FIG. 8 shows one of the operating conditions of the compressor 100, with the piping affected by the flow of the fluid O identified in boldface characters. To be more specific, the piston 105 lies in the position nearest to the head 104b of the cylinder 104 and the slide valve 103 is fully open.

In this configuration, most of the gas intake I is recirculated in the intake chamber 101 and the compressor 100 provides only 25% of the total capacity. Of course, other embodiments of the invention may be developed that are not illustrated here, wherein the flow diverter switch has a structural design that differs from the one described herein, and may even be of a known type.

It is important to emphasize that the fluid intake piping leading to the cylinder may be of any shape or size, and may be arranged in various positions inside the compressor casing.

It should also be noted that the above-mentioned values of 25%, 50% and 75% of the compressor's capacity simply indicate preferred values used by the manufacturer for the sake of convenience and are consequently not binding.

Said values are used simply to facilitate the reader's understanding of how the compressors 1 and 100 function, and their purpose is merely to illustrate an example of compressor operating conditions relating respectively to a minimum capacity, intermediate capacity and near-total capacity.

On the strength of the above considerations, it is therefore clear that the volumetric screw compressor of the invention achieves the objects and offers the advantages described above.

On implementation, changes may be made to the volumetric compressor of the invention, e.g. positioning the channels on the shell of the cylinder in another way, in order to obtain flow rate values different from those described previously, simply by way of example.

As a result, the circuit for delivering the fluid to and from the cylinder may have a different structural layout compared to the one mentioned previously, without affecting the advantages offered by the present invention.

Where the technical characteristics stated in the claims are followed by reference signs, these have been added only to facilitate the reading of the claims, so such reference signs shall have no limiting effect on the coverage for each of the elements they identify for said illustrative purposes.

All the variants described and mentioned, but not illustrated in the attached drawings, shall come within the scope of the following claims and, as such, shall be covered by the present patent.

1. Improved volumetric screw compressor comprising:
a casing containing an intake chamber and a delivery chamber;
a pair of screw rotors, coming between said intake chamber and said delivery chamber;
a container for containing a high-pressure fluid, associated with said casing;
a capacity regulating device associated with said casing, which includes:
a slide valve cooperating externally with said rotors;
a fluid-operated actuator comprising a cylinder with a bottom and a head provided with a through hole for the passage of a stem having one end associated with a piston sliding inside said cylinder, and the opposite end associated with said slide valve;
a plurality of channels obtained inside said cylinder;
at least one delivery pipe for the fluid, connecting said container to one of said channels;
a plurality of outlets for the fluid connecting said channels to said intake chamber;
a plurality of shut-off solenoid valves, installed in said outlets;
at least one control unit, electrically connected to said shut-off solenoid valves,
wherein the top end of said slide valve faces said delivery chamber so that said stem connecting said slide valve to said piston comes under a compressive force.

2. Compressor according to claim 1, wherein it comprises elastic means placed between said piston and said bottom of said cylinder, designed to cooperate with said piston in order to return said slide valve to its starting position when said compressor is switched off.

3. Compressor according to claim 2, wherein said elastic means are arranged in line with an active chamber containing oil and created inside said cylinder, between said piston and said bottom.

4. Compressor according to claim 3, wherein said channels are obtained in the shell of said cylinder in line with said active chamber.

5. Compressor according to claim 1, wherein said channels are arranged at different distances from said bottom of said cylinder.

6. Compressor according to claim 1, wherein said channels are aligned with one another.

7. Compressor according to claim 4, wherein two of said channels substantially occupy the central part of said shell of said cylinder.

8. Compressor according to claim 1, wherein said cylinder of said fluid-operated actuator is obtained on said casing, with which it forms a single body.

9. Compressor according to claim 1, wherein said bottom of said cylinder is arranged so as to face said intake chamber.

10. Compressor according to claim 1, wherein said stem is arranged in line with a central area of said casing connected to the intake chamber.

11. Compressor according to claim 1, wherein said slide valve comes between said rotors and said container.

12. Compressor according to claim 1, wherein said container consists of a sump obtained in the bottom of said casing.

13. Compressor according to claim 1, wherein said container consists of an outside tank communicating with said casing by means of piping.

14. Compressor according to claim 1, wherein said control unit comprises electric/electronic means for opening/closing said solenoid valves.

15. Compressor according to claim 3, wherein said capacity regulating device comprises a flow diverter switch that connects said active chamber to said container and to said intake chamber.

16. Compressor according to claim 15, wherein said switch comprises a static flow diverter, removably associated with said shut-off solenoid valves, so as to obtain discretely or continuously variable compressed fluid flow rates, depending on the position of said shut-off solenoid valves.

17. Compressor according to claim 15, wherein said static flow diverter consists of a gasket placed between said shut-off solenoid valves and said casing, wherein the paths of the lubricant oil are defined.

18. Compressor according to claim 1, wherein one of said shut-off solenoid valves is contained inside said delivery pipe.
